(19) United States
(12) Patent Application Publication
(10) Pub. No.: US 2026/0342173 A1
(43) Pub. Date: Oct. 29, 2026

(54) FAN MOTOR STRUCTURE

(71) Applicant: HUAZHUN TECH CO., LTD., Tainan (TW)

(72) Inventor: Jin Long LAI, Kaohsiung (TW)

(73) Assignee: HUAZHUN TECH CO., LTD., Tainan (TW)

(21) Appl. No.: 19/282,245

(22) Filed: Jul. 28, 2025

(30) Foreign Application Priority Data
Apr. 25, 2025 (TW) 114115726

(51) Int. Cl. H02K 7/00; H02K 7/14

(52) U.S. Cl. CPC H02K 7/003; H02K 7/14; H02K 2207/00

(57) ABSTRACT

The invention discloses a fan-motor structure featuring a self-lubricating shaft, either wholly formed from a self-lubricating polymer material or metal-based with a self-lubricating coating. Stable rotation is achieved without continuous oil supply, while micro-dosing a small amount of oil or grease remains optionally available under extreme load, cold-start, or extended-life conditions to further reduce friction. The structure integrates a hollow cylindrical tube, a base, and a rotor, together with a coil assembly and a control circuit board assembly that establish an electromagnetic drive path. This design delivers low friction, outstanding wear resistance, excellent heat dissipation, and vibration stability, thereby extending service life and cutting maintenance costs for consumer electronics, industrial machinery, and automotive applications.

### BACKGROUND OF THE INVENTION

### 1) Field of the Invention

The present invention belongs to the field of fan-motor technology and, more particularly, to a motor structure that employs a self-lubricating shaft or a self-lubricating coating to achieve low friction, wear resistance, and efficient heat dissipation. To overcome heat-dissipation issues, the invention may adopt an integrated design in which the self-lubricating shaft is combined with a hollow cylindrical tube, ensuring continuous power transmission among the components and adequate heat dissipation. This greatly improves overall operational stability and reliability and prolongs service life. A small amount of lubricant can be selectively added, when necessary, to enhance cold-start performance or high-load durability. The technology is applicable to consumer electronics, industrial equipment, and other low-noise, high-efficiency applications, offering significant innovation and broad applicability.

### 2) Description of the Prior Art

In the field of fan motors, conventional technology is widely used. As shown in FIG. 1, the basic structure comprises a conventional base (70), conventional housing (71), conventional shaft (72), powder metallurgy bearing (73), conventional coil (74), electronic circuit board (75), conventional rotor (76), rotor blades (77), rubber magnet (78), conventional retaining ring (79), conventional bottom cover (80), and conventional snap ring (81). Although this configuration met basic operational requirements in early applications, the design of each component has numerous shortcomings, resulting in unstable performance under high load or long-term operation, poor heat dissipation, and high maintenance costs.

First, the conventional base (70) in a fan motor is typically made of metal or engineering plastic, serving as the main support for the entire system. However, its structural design does not fully account for deformation from long-term vibration and impact, leading to insufficient fixation stability and reduced support strength as connecting parts age. The corresponding conventional housing (71), usually in the form of a hollow cylinder, is used to mount the conventional shaft (72). Yet, traditional fixation methods such as riveting or press-fitting often loosen or deform under continuous operation and vibration, compromising the overall structural integrity and concentricity.

Conventional shafts (72) are mostly made of stainless steel or high-hardness alloys, whose rigidity can withstand centrifugal forces at high rotational speeds. However, during actual operation, uneven loading can cause axial displacement of the shaft, destabilizing overall power transmission, accelerating mechanical wear, and risking structural failure. Powder metallurgy bearings (73) were introduced to support relative motion between the shaft and housing; their porous structure can retain lubricating oil to reduce friction and noise. Yet these bearings heavily rely on oil lubrication, which can evaporate, degrade, or accumulate sludge under prolonged high-temperature or continuous operation, causing the friction coefficient to rise sharply and leading to operational roughness, increased noise, or even motor seizure.

The conventional coil (74) surrounds the base to generate an alternating magnetic field when energized, driving the conventional rotor (76). However, the limited space and inadequate heat-dissipation design trap significant heat during operation, causing local temperatures to remain high and further degrading the operating environment of powder metallurgy bearings (73) and other electronic components. The electronic circuit board (75), usually placed near the coil for signal transmission and electrical control, also suffers from poor cooling due to confined space and complex wiring, often leading to local overheating, circuit failures, or diminished component performance, thereby threatening the motor's overall stability.

The conventional rotor (76), which converts electrical energy into mechanical energy, typically has a simple design. The rotor blades (77) push air to create airflow for cooling, but the conventional aerodynamic design is not optimized, resulting in inefficient airflow direction and propulsion. Moreover, rubber magnets (78) and conventional retaining rings (79) are often placed inside or around the rotor to maintain the required magnetic field distribution. Under oil-lubricated and high-temperature conditions, these magnetic elements are prone to contamination and heat accumulation, causing magnetic degradation and weakening the driving efficiency, thus failing to achieve ideal energy conversion.

Additionally, to protect the entire mechanism, conventional designs include a bottom cover (80) and conventional snap ring (81) at the motor's base. The bottom cover serves to shield and protect internal structures while providing additional support, but its material and structural design often struggle with prolonged high-frequency vibration and external impacts. The snap ring restricts the rotor's axial movement, ensuring its fixed position during high-speed rotation, yet due to material fatigue or poor assembly workmanship, the snap ring can detach or fail, further compromising structural integrity.

In terms of assembly, the components of the conventional fan motor shown in FIG. 1 are often joined by simple riveting, press-fitting, or basic fastening methods. Over time and under changing environmental conditions, these joints can loosen, deform, or suffer localized wear, causing uneven vibration and noise during high-speed operation, which severely affects product stability and service life.

Heat dissipation is also a major challenge in conventional technology. Because lubricants in powder metallurgy bearings (73) easily degrade and the conventional coil (74) and electronic circuit board (75) are packed tightly, heat cannot dissipate quickly, causing components to remain at high temperatures for extended periods and accelerating friction and material aging. High temperatures not only degrade lubrication but may also impair the performance of rubber magnets (78) and conventional retaining rings (79), gradually reducing electromagnetic drive efficiency and ultimately affecting the overall performance of the fan motor.

In summary, traditional fan motor structures as shown in FIG. 1 exhibit significant defects in both design philosophy and manufacturing processes. The lubrication system's over-reliance on oil causes evaporation, degradation, and sludge accumulation under high temperatures or prolonged operation. Insufficient heat-dissipation space leads to local overheating of the coil and electronic circuit board, accelerating component aging. Simple structural connections are prone to loosening, causing misalignment and noise under high-vibration conditions. Magnetic components degrade from oil contamination and heat, impairing electromagnetic driving performance. Auxiliary parts such as bottom covers and snap rings also weaken overall stability due to material fatigue and poor connections. These issues become particularly severe in modern applications demanding efficient cooling, low noise, and long-term stable operation, limiting the adoption of conventional fan motors in high-performance equipment.

### SUMMARY OF THE INVENTION

In view of the numerous defects common in the prior art—such as lubricant degradation, insufficient heat dissipation, and unstable component connections—the present invention provides a novel fan motor structure. This structure employs advanced self-lubricating shaft technology, combined with an integrated design to significantly reduce reliance on external lubrication. Specifically, the shaft surface is uniformly coated with a self-lubricating polymer material, thereby maintaining an extremely low coefficient of friction and outstanding wear resistance during long-term operation. In concert with the coil assembly and circuit board forming an electromagnetic drive path, the motor as a whole can operate stably even without continuous oil supply, while selectively dosing lubricant under extreme high-load or cold-start conditions. This technology not only drastically lowers routine maintenance costs but also effectively avoids seizure risks caused by sludge buildup, achieving truly maintenance-free, low-noise operation to meet the stringent demands for high-efficiency, stable performance in modern electronic and industrial applications.

Another object of the present invention is to provide a design scheme with multiple embodiments, allowing manufacturers to tailor the material formulation to actual application requirements. Specifically, for applications demanding extreme lightweight and environmental considerations, the shaft may be made entirely of self-lubricating polymer material; whereas for cases requiring higher structural strength and heavy-load operation, a metal shaft coated with a self-lubricating layer may be selected, thus achieving an optimal combination of strength and lubrication performance to satisfy various application scenarios.

A further object of the present invention is to provide a design that allows selective supplementation of a small amount of lubricating oil or grease under extreme high-load, low-temperature startup, or extended-life requirements to further enhance performance.

The invention further provides a fan motor that combines high heat-dissipation efficiency with stable operation. This fan motor is characterized by a self-lubricating polymer coating or overlayer on the shaft surface, which, together with the base and hollow cylindrical tube, forms a continuous heat-dissipation channel. The continuous channel quickly conducts and expels heat generated during operation, effectively solving the poor heat dissipation issue associated with conventional oil-lubricated bearings prone to sludge buildup. Additionally, this design mitigates the impact of high temperature on magnetic components, ensuring the motor maintains excellent performance stability and durability under prolonged operation.

Another important object of the invention is to provide a structurally integrated fan motor. By tightly coupling the hollow cylindrical tube and base through injection molding, riveting, or other high-strength fixing techniques, the entire motor structure maintains superior mechanical strength and stability under extreme conditions such as high-speed rotation and prolonged vibration. Compared with conventional designs using independent tubes with powder metallurgy bearings, ensuring one-piece molding or high-strength fixation of the tube and base significantly enhances heat-dissipation efficiency and prevents eccentricity and abnormal vibration due to joint loosening, further ensuring overall system safety and reliability.

The invention also proposes a simplified design concept that eliminates traditional independent bearing housings and additional thrust washers by using the hollow cylindrical tube as part of the shaft support structure, achieving overall lightweight and space-saving. This design not only reduces part count and assembly complexity but also ensures unobstructed heat-dissipation paths, effectively avoiding adverse effects on heat-dissipation efficiency caused by oil contamination or component obstruction, thereby further enhancing motor system performance and reliability.

To achieve multiple technical objectives, the invention employs self-lubricating shaft technology by using a self-lubricating polymer throughout the shaft or applying a polymer self-lubricating coating on its surface. This design not only maintains low friction and excellent wear resistance during prolonged operation without continuous oil supply but also preserves the flexibility to selectively add oil when needed, solving the problems of lubricant degradation and sludge buildup in traditional systems.

Meanwhile, the invention adopts advanced fixation techniques-such as injection molding, riveting, additive manufacturing, or press-/snap-fitting—to tightly couple the hollow cylindrical tube and base, forming an integrated structural support. This integration significantly enhances stability in high-vibration and high-temperature environments and provides excellent heat-dissipation paths, further securing safe and efficient long-term operation.

In addition, to address diverse application needs, the invention contemplates structural versatility. For scenarios requiring high-strength support, a metal shaft substrate coated with a self-lubricating polymer can be selected to perfectly combine metal strength with low-friction polymer characteristics.

Compared to known techniques, the present invention provides the following significant advantages: (1) By incorporating a self-lubricating mechanism that operates without continuous oil supply while allowing optional oil replenishment, it completely avoids lubricant degradation and sludge buildup, thereby significantly reducing maintenance costs; (2) The integrated structural design tightly unites the hollow cylindrical tube and base, greatly enhancing vibration resistance and heat-dissipation efficiency; (3) The self-lubricating shaft coupled with the rotor notably reduces noise and friction during high-speed rotation, extending product lifespan; (4) The system maintains stable operation under high-temperature and high-load conditions, effectively preventing lubrication failure; (5) Through various embodiments-such as an all-polymer shaft or a metal substrate coated with a self-lubricating layer—it flexibly meets different strength and application requirements; (6) The integrated structure design lightens the overall system and ensures smoother heat dissipation, making it especially suitable for space-constrained applications requiring high cooling efficiency, thus achieving an optimal balance of performance and efficiency.

### BRIEF DESCRIPTION OF THE DRAWINGS

FIG. 1 Schematic diagram of the prior art.

FIG. 2 Exploded view of the overall fan motor structure of the first embodiment of the present invention.

FIG. 3 Schematic illustration of the all-polymer self-lubricating shaft configuration of the first embodiment.

FIG. 4a Exploded view of the overall fan motor structure of the second embodiment of the present invention.

FIG. 4b Schematic illustration of the metal-based coated shaft configuration of the second embodiment.

FIG. 5a Schematic of the hollow cylindrical tube and base in a separated state.

FIG. 5b Schematic of the hollow cylindrical tube and base in a joined state.

FIG. 5c Schematic of the integrated hollow cylindrical tube and base structure.

FIG. 6 Comparison chart of noise levels and lifespan among the various structures.

FIG. 7a First structural schematic of the second embodiment.

FIG. 7b Second structural schematic of the second embodiment.

FIG. 7c Third structural schematic of the second embodiment.

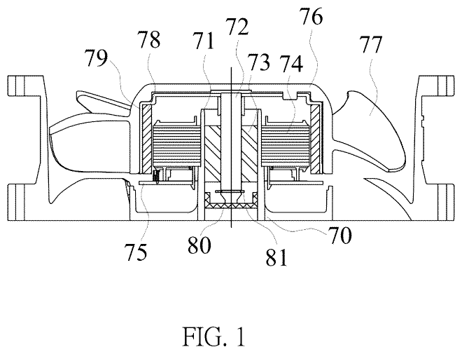

### DETAILED DESCRIPTIONS OF THE PREFERRED EMBODIMENTS

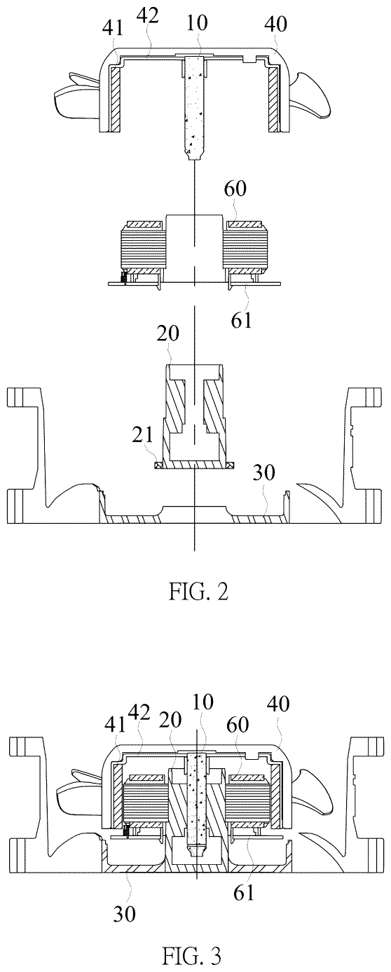

The following describes the implementation method of the first embodiment of the present invention. The content is based primarily on the technical features of claims 1, 2, and 7, supplemented by structural improvements from claims 4 and 5. The following sections explain, step by step, the functions, positions, and interconnections of each main component, with detailed reference to FIGS. 2, 3, 5a, 5b, 5c, and 6.

Referring to the exploded view shown in FIG. 2, the fan motor structure of the present invention comprises a self-lubricating shaft (10), a hollow cylindrical tube (20), a base (30), a rotor (40), a coil assembly (60), and a circuit board (61). The self-lubricating shaft (10) is entirely made of a modified polymer material, whose self-lubricating effect relies on the gradual release of a solid lubricant within the polymer matrix, thereby forming a uniform lubricating film on the shaft surface. The shaft (10) is precisely positioned inside the hollow cylindrical tube (20). The rotor (40) is fixed to the exterior of the self-lubricating shaft (10). The fixed magnet (41) and magnetic-retaining ring (42) are installed at corresponding locations on the rotor (40) to cooperatively form a stable magnetic field structure; the fixed magnet (41) may be made of various materials, including sintered ferrite, neodymium-iron-boron, samarium-cobalt, or rubber magnets. The coil assembly (60) and circuit board (61) are respectively arranged at suitable locations to generate and control the alternating magnetic field that drives the rotor (40).

Referring to the schematic shown in FIG. 3, this embodiment employs an all-polymer self-lubricating shaft (10). The polymer matrix of the self-lubricating shaft (10) may contain 5-20 wt % solid lubricant with an average pore diameter of 0.1-1 μm. Its main function is to utilize the solid lubricant embedded in the polymer material, which is gradually released through frictional heat and pressure, to form a thin and uniform lubricating film on the outer diameter of the shaft. This film maintains close radial contact with the inner wall of the hollow cylindrical tube (20), i.e., the continuous inner surface formed circumferentially along the tube. Such radial contact ensures that the lubricating film can continuously exist between the entire sliding interface of the shaft and the tube's inner wall, thereby effectively reducing the friction coefficient and minimizing localized wear. To ensure uniform distribution of the lubricating film, the shaft surface is precision-machined to a surface roughness of approximately 0.4 μm (10-point average), further preventing local protrusions from causing marring. This technical principle fully explains the gradual release of the solid lubricant from the polymer material, thereby achieving long-term low-maintenance (no need for continuous oil replenishment) and low-noise operation, although the invention is not limited to the above example.

In this embodiment, the self-lubricating mechanism itself provides the low friction and wear resistance required for normal operation, so continuous external lubrication is unnecessary during regular use, though optional oil replenishment can be performed under extreme conditions. A user may, depending on actual load and environmental conditions, apply 0.01-0.05 mL of high-viscosity synthetic oil or equivalent grease at the mating surface between the shaft and the hollow cylindrical tube to reduce cold-start friction and extend service life under extreme conditions; this action does not compromise the core advantages of the self-lubricating mechanism of the present invention.

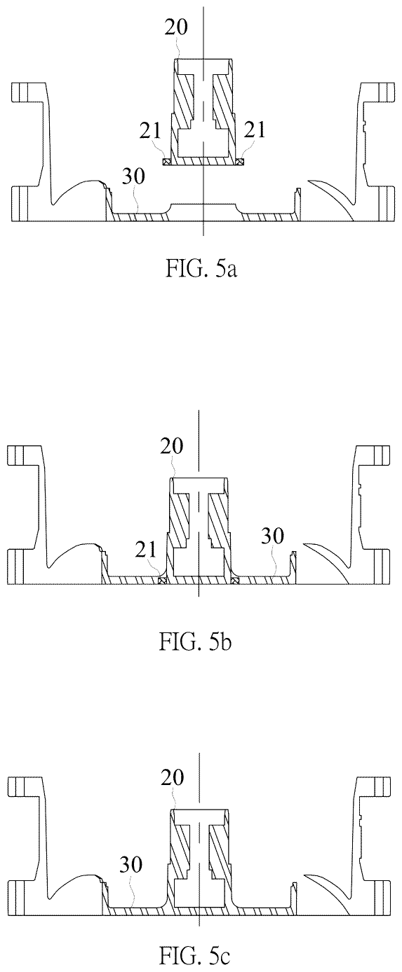

Preferably, as shown in FIGS. 5a and 5b, an auxiliary structure (21) is added to the tube to fix the hollow cylindrical tube (20) and the base (30) together via injection molding, riveting, or other high-strength connection methods. The material may be modified with fillers (e.g., glass fiber, carbon fiber, ceramics, etc.) to significantly enhance thermal conductivity, achieving 1 W/m·K or higher. In this embodiment, when the base (30) and the hollow cylindrical tube (20) are separated, the auxiliary structure (21) typically enhances connection stability. FIG. 5a shows the initial state where the tube (20) and the base (30) are not yet combined; at this time, the auxiliary structure (21) may feature embossments or protrusions to provide a more secure bond during overmolding, riveting, or press-fitting processes. FIG. 5b schematically illustrates the tube (20) and the base (30) entering the connection process, where the auxiliary structure (21) has begun to exert its fixing support effect.

However, if the present invention employs an integrated design (as shown in FIG. 5c), the hollow cylindrical tube (20) and the base (30) can be directly combined into a single unit via injection molding (using filled, modified materials), monolithic metal processing, or other advanced techniques, without requiring a separate auxiliary structure (21). Under this integrated connection method, the overall structure provides both robust mechanical support and a continuous heat-dissipation channel, allowing generated heat during operation to be rapidly expelled, thereby significantly enhancing heat dissipation efficiency and vibration resistance.

In this embodiment, the hollow cylindrical tube (20) may take the form of a blind hole while still achieving continuous transmission and effective heat dissipation in cooperation with the self-lubricating shaft (10) made of polymer or metal material. When the hollow cylindrical tube (20) is a blind hole, its bottom can be integrally formed with the tube body or sealed via additive manufacturing, press-fitting, or snap-fitting, thereby omitting the need for a top cap (22), friction pad (23), and axial positioning retaining ring (50). This blind-hole structure is more convenient for applications with limited space or special installation requirements, and may also be modified with polymer materials or solid lubricants to provide low friction and long-term stable operation inside the blind hole. The closed-bottom design reduces part count and lowers potential leakage risks, making it particularly suitable for sealed or debris-sensitive environments.

The rotor (40) is fixed to the exterior of the self-lubricating shaft (10), and its operation relies on precise axial positioning. By the cooperative formation of a stable magnetic field structure between the coil assembly (60) and the rotor (40), axial displacement of the self-lubricating shaft (10) relative to the rotor (40) during high-speed rotation-caused by vibration or eccentricity—is effectively prevented. Additionally, the fixed magnet (41) and magnetic-retaining ring (42) are respectively arranged inside or around the rotor (40) to form the necessary magnetic field structure, ensuring efficient energy conversion of the rotor under electromagnetic drive; these two elements are known variations and are not improvement points of the present invention.

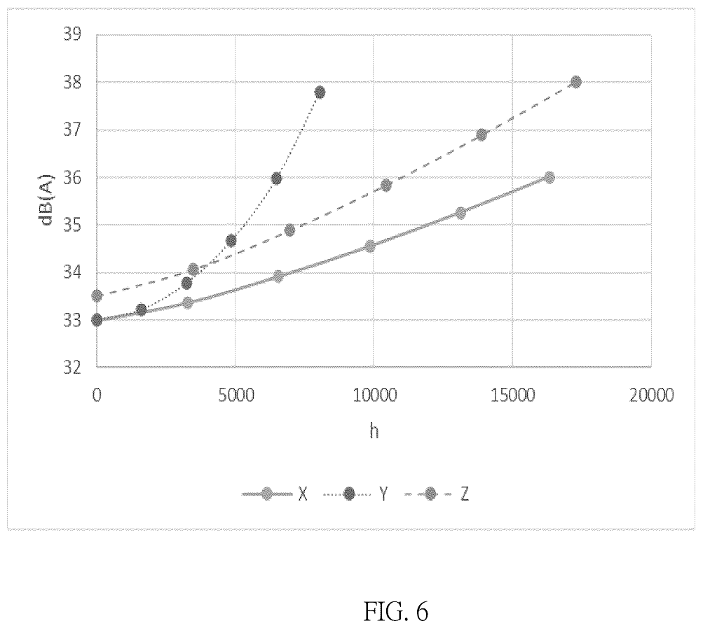

Referring to FIG. 6, accelerated mean time to failure (MTTF) tests were conducted in a constant-temperature chamber at 80° C.±2° C., using the same rotor and fan dimensions (40 mm×28 mm). The termination criterion was set at 10% cumulative sample failure. Three fan motor structures were compared: the present invention's structure (X), the conventional oil-bearing structure (Y), and the conventional ball-bearing structure (Z). Tests ran at low speed (3000 RPM), with initial noise levels recorded at 33 dB(A) for both X and Y, and slightly higher at 33.5 dB(A) for Z. As cumulative run time increased, noise levels rose; data show that under 3000 RPM conditions, Z exhibited higher noise, likely due to ball-bearing noise at low speed. In contrast, X's noise only rose to 36 dB(A) after approximately 16,320 hours, demonstrating more stable low-noise performance. Y reached 37.8 dB(A) at 8,040 hours, reflecting rapid noise increase and shorter life due to oil degradation and mechanical wear. Overall, after 16,320 hours, X showed only a 3 dB(A) increase, nearly doubling the operational lifespan versus Y and maintaining extremely low noise at low speed, indicative of effective friction and vibration control. These MTTF data confirm that the present invention's fan motor structure (X) maintains low noise during long-term operation and that its self-lubricating shaft technology and integrated connection method effectively extend mechanical life, substantially enhancing product reliability and durability.

The coil assembly (60) and circuit board (61) are implemented in a modular design and are fixedly mounted inside the hollow cylindrical tube (20) or near the base (30). The coil assembly (60) comprises a stator core of stacked silicon steel laminations wound with multiple turns of enamelled copper wire around its periphery. When the circuit board (61) applies current to the coil assembly (60), alternating magnetic flux of the same frequency is generated within the core, which, together with the fixed magnet (41) and magnetic-retaining ring (42), forms a closed magnetic circuit. This applies periodic magnetic forces to the rotor (40), enabling continuous rotation and stable torque output. The circuit board (61) is responsible for controlling and monitoring the overall drive signals, ensuring high efficiency and stability across all operating conditions.

As shown in FIGS. 2, 3, 5a, 5b, 5c, and 6, this embodiment, by employing an all-polymer self-lubricating shaft (10) and integrating the hollow cylindrical tube (20) with the base (30), not only forms continuous transmission and heat-dissipation channels but also maintains stable self-lubrication over the long term. This self-lubrication relies on the mechanism of a uniform lubricating film gradually released from solid lubricant within the polymer material, further reducing friction and wear while achieving maintenance-free and low-noise operation. Combined with precision machining and modular assembly of each component, the invention can sustain stable performance under high-temperature, high-load, and prolonged operation conditions, greatly extending product lifespan and enhancing thermal and vibration resistance. These technological innovations are fully demonstrated in FIGS. 2, 3, the series of FIG. 5, and FIG. 6, resulting in a fan motor structure with high performance and low maintenance characteristics.

In applying the self-lubricating-shaft technology, the present invention may employ various polymer materials or polymer coatings to ensure low friction, wear resistance, and high stability under severe conditions such as high rotational speeds, prolonged operation, and elevated temperatures. Examples of common polymers suitable for self-lubrication include: PTFE (Polytetrafluoroethylene), which has an extremely low coefficient of friction and excellent chemical stability, is one of the most common low-friction coating materials for shaft surfaces; PEEK (Polyetheretherketone), offering high strength, heat resistance, and chemical resistance, is often used in components demanding high mechanical strength and wear resistance, and its modified versions can provide enhanced self-lubrication; POM (Polyoxymethylene), known for its outstanding mechanical properties and wear resistance, is commonly used in sliding parts and, when suitably modified with solid lubricants, becomes highly suitable for self-lubricating applications; UHMWPE (Ultra-High-Molecular-Weight Polyethylene), with an extremely low friction coefficient and excellent wear resistance, is especially apt for self-lubricating shafts requiring long-term stable operation; PI (Polyimide), which maintains good strength and wear resistance at high temperatures, can be used as a self-lubricating coating under harsh thermal conditions; PU (Polyurethane), combining good elasticity with wear resistance, is suitable for parts that must absorb vibration while reducing friction.

Moreover, these polymers can be further modified in practice for instance, by incorporating solid lubricants such as graphite, molybdenum disulfide, or talc, or by employing cross-linking and filler-reinforcement techniques—to further enhance their self-lubricating performance, wear resistance, and thermal-management capabilities. Through such modifications, even under high loads, prolonged operation, or harsh environments, the materials maintain low friction, minimal wear, and efficient heat dissipation, fully meeting the technical requirements of the self-lubricating shaft and hollow-tube structure in the present invention.

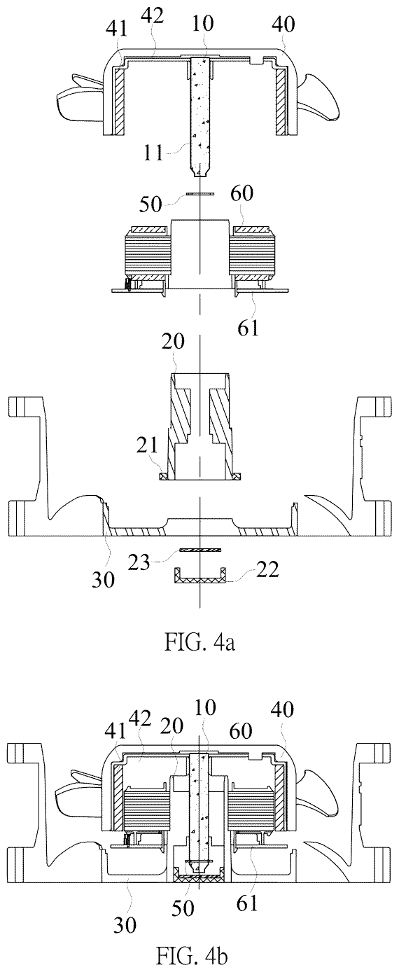

Referring to FIGS. 4a and 4b, this embodiment is the second embodiment. Its main components include the self-lubricating shaft (10), hollow cylindrical tube (20), auxiliary tube structure (21), top cap (22), friction pad (23), base (30), rotor (40), axial positioning retaining ring (50), coil assembly (60), and circuit board (61). Unlike the first embodiment, this one employs the metal-substrate coated-shaft scheme shown in FIG. 4a: the self-lubricating shaft (10) is a metal shaft coated on the outside with a self-lubricating polymer layer (11) per claim 3, combining metal strength with polymer low-friction properties. The hollow cylindrical tube (20) is designed as a through-hole structure, one end of which is fitted with the top cap (22) and friction pad (23) as detailed in FIG. 4a. In this embodiment, the auxiliary tube structure (21) tightly connects the hollow cylindrical tube (20) and the base (30) via advanced processes such as overmolding or riveting; the rotor (40) is fixed around the self-lubricating shaft (10) and its axial position is precisely maintained by the axial positioning retaining ring (50). The fixed magnet (41), retaining ring (42), coil assembly (60), and circuit board (61) are arranged according to the reference numerals to form an efficient drive and control system.

Referring to FIGS. 4a and 4b, in this embodiment the self-lubricating shaft (10) uses a metal core coated externally with a self-lubricating polymer layer (11). The polymer layer (11) contains 5-20 wt % solid lubricant with an average pore diameter of 0.1-1 μm. Its outer diameter maintains tight radial contact with the inner wall of the hollow cylindrical tube (20)—i.e., the continuous circumferential inner surface—ensuring the lubricating film persists around the entire sliding interface. After precision surface machining, the coating's surface roughness is approximately 0.4 μm (10-point average). During operation, frictional heat and pressure gradually release the solid lubricant, forming a thin, uniform lubricating film on the layer surface. This film significantly reduces the friction coefficient at contact points between the self-lubricating shaft (10), the hollow tube (20), and the rotor (40), prevents metal-to-metal wear and local hot spots, and realizes long-term maintenance-free, low-noise operation.

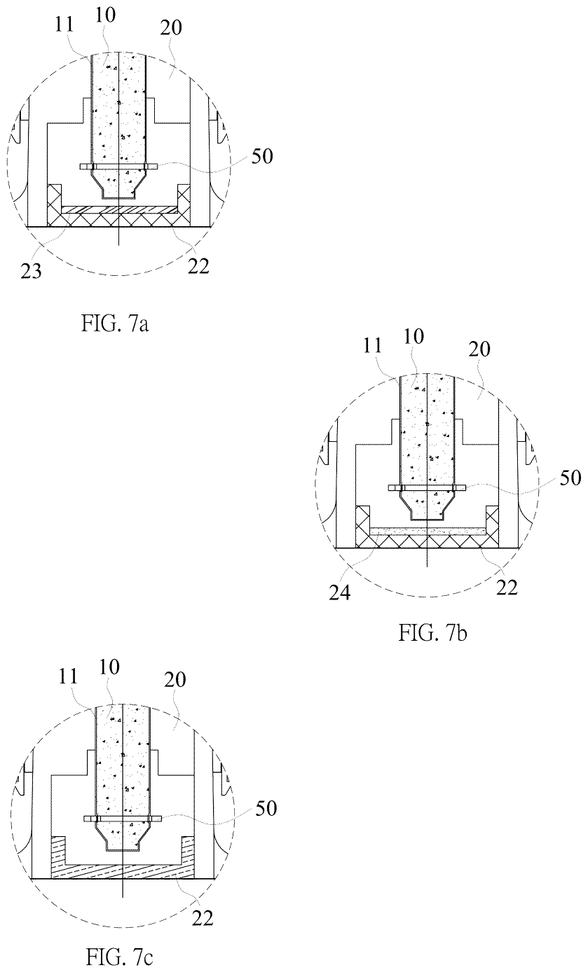

In this embodiment, the hollow cylindrical tube (20) is designed as a through-hole structure, creating a continuous passage that promotes rapid heat conduction and dissipation, further enhancing overall cooling efficiency. At one end of this through hole, a top cap (22) is provided in accordance with claim 6. To suit various applications, the top cap (22) may take one of three forms: FIG. 7a: a metal top cap with a friction pad (23), leveraging the rigidity of metal and the friction-reducing action of the wear pad; FIG. 7b: a metal top cap coated with a polymer layer (24), using the polymer to improve surface friction characteristics; FIG. 7c: an all-polymer top cap, offering inherently low friction and excellent wear resistance. In each configuration (7a, 7b, 7c), if the self-lubricating shaft (10) shifts during operation (e.g., due to movement or vibration), it will frictionally engage the underlying cap structure. The top cap (22) not only protects the tube's interior and guards against debris ingress but also aids in overall heat dissipation and maintains continuity and stability between the tube and internal components.

The rotor (40) is mounted around the self-lubricating shaft (10), with its operation relying on precise axial positioning. An axial positioning retaining ring (50) ensures no axial displacement occurs at high rotational speeds. Fixed magnets (41) and magnetic-retaining rings (42) are arranged inside or around the rotor to form a stable magnetic field structure, which, together with the alternating magnetic field generated by the coil assembly (60), drives continuous rotation of the rotor. The circuit board (61) controls the overall electromagnetic drive signals, ensuring high efficiency and stability under all operating conditions. This component arrangement and connection are also illustrated in FIG. 4a, while FIG. 6's comparison of operating time (h) versus noise level (dB(A)) further confirms this embodiment's marked advantages in noise control and service life.

This embodiment's design-featuring a metal core self-lubricating shaft coated with a polymer layer (11), a through-hole hollow tube (20) with its top cap (22), and a continuous drive and cooling channel-creates an unbroken path for torque transmission and heat dissipation. The auxiliary tube structure (21) firmly connects the hollow tube (20) to the base (30), enhancing overall mechanical support. By the principle of gradual solid lubricant release within the polymer coating to form a lubricating film, the system maintains low friction, low noise, and stable operation even under high temperatures and heavy loads. This design not only extends product lifespan and greatly reduces maintenance costs but is especially suited for high-strength, durable, and energy-efficient applications in consumer electronics, industrial equipment, automotive, and aerospace sectors.

What is claimed is:

1. A fan motor structure, comprising:
a self-lubricating shaft having a shaft surface formed from a polymer material that provides self-lubricating and low-friction properties;
a hollow cylindrical tube configured to secure, support, and surround the self-lubricating shaft;
a base;
a coil assembly disposed around the hollow cylindrical tube and adapted to generate an alternating magnetic field when energized;
a circuit board electrically connected to the coil assembly to control energization and operational states of the coil assembly; and
a rotor fixed to the self-lubricating shaft and positioned between the hollow cylindrical tube and the base so that the rotor rotates about the self-lubricating shaft;
wherein the self-lubricating shaft is fixed inside the hollow cylindrical tube; the hollow cylindrical tube is fixed to the base; the coil assembly and the circuit board cooperate to apply periodic magnetic forces to the rotor; and the polymer solid-lubricant material of the self-lubricating shaft remains in continuous contact with an inner wall of the hollow cylindrical tube so as to continuously provide self-lubrication and structural stability during long-term operation.

2. The fan motor structure of claim 1, wherein the self-lubricating shaft is entirely made of a polymer material having self-lubricating capability.

3. The fan motor structure of claim 1, wherein the self-lubricating shaft comprises a metal shaft whose outer surface is coated with a self-lubricating polymer layer.

4. The fan motor structure of claim 1, wherein the hollow cylindrical tube and the base are integrally formed by injection-molding, riveting, additive manufacturing, or press-/snap-fitting so as to form a continuous heat-dissipation passage.

5. The fan motor structure of claim 1, wherein the hollow cylindrical tube is made of a metal or another material having self-lubricating capability.

6. The fan motor structure of claim 1, wherein, when the hollow cylindrical tube is a through-hole type, a top cap is disposed at one end of the through hole, the top cap being selected from:
(a) a metal top cap used together with a friction pad;
(b) a metal top cap whose surface is covered with a polymer layer; or
(c) a top cap entirely made of a polymer material.

7. The fan motor structure of claim 1, wherein, when the hollow cylindrical tube is a blind-hole type, the tube is made entirely of a metal or entirely of a polymer material.

8. The fan motor structure of claim 1, wherein a small amount of lubricant oil or grease can be selectively added between the self-lubricating shaft and the hollow cylindrical tube to further reduce frictional resistance and improve operational stability under extreme high-load, low-temperature start-up, or extended-life conditions.
